(19) United States
(12) Patent Application Publication
(10) Pub. No.: US 2005/0241159 A1
(43) Pub. Date: Nov. 3, 2005

(54) Wear-resistant stainless cutting element of an electric shaver, electric shaver, and method of producing such a cutting element

(75) Inventors: Hubert Sjoerd Blaauw, Drachten (NL); Hans De Beurs, Drchten (NL)

Correspondence Address: PHILIPS INTELLECTUAL PROPERTY & STANDARDS, P.O. BOX 3001, BRIARCLIFF MANOR, NY, 10510, US

(73) Assignee: koninkilijke phillips electronics n.v.

(21) Appl. No.: 10/523,431

(22) PCT Filed: Jul. 22, 2003
(86) PCT No.: PCT/IB03/03179

§ 371 Date: Jan. 28, 2005

(51) Int. Cl. B26B 21/54

(52) U.S. Cl. 30/346.54

(57) ABSTRACT

Disclosed is a cutting element as used in an electric shaver. Said element is manufactured from maraging or precipitation-hardenable stainless steel with a surface hardened by plasma nitriding. The cutting element is plasma nitriding hardened on all surfaces of the blade, and a plasma nitriding hardened layer comprises a surface top layer of steel supersaturated with nitrogen and a diffusion layer adjoining the top layer with a hardness ranging from the hardness of the top layer to the hardness of the steel before hardening by means of plasma nitriding. Also disclosed is an electric shaver comprising at least one of the above cutting elements, as well as a method of manufacturing a cutting element.

The invention relates to a cutting element as used in an electric shaver (also known as additive type shavers), manufactured from maraging or precipitation-hardenable stainless steel or austenitic stainless steel with a surface hardened by plasma nitriding. The invention also relates to an electric shaver provided with such a cutting element and a method of manufacturing a cutting element.

Since the introduction of the Philips Coolskin® additive shaver, an electric shaver that can be used with water, and which uses an additive released during operation, it has been found that the stainless steel outer cutting element shows unexpected high wear, leading to customer complaints. It is therefore necessary to provide a more wear-resistant blade, that is, a blade made from a harder material. On the other hand, the blade should not just be sufficiently hard, but also very corrosion-resistant. Corrosion resistance is less of an issue with conventional shavers, but because of the concept of the Coolskin Philishave the blade is in much closer contact with moisture. Although above especially mentioned in relation to the Coolskin Philishave type of shaver it will be clear that improvement of the corrosion resistance of a cutting element of another type of shaver is also advantageous. At present the material used for the manufacture of these cutting elements is stainless maraging steel. This is a steel type with good corrosion resistance qualities but with moderate wear resistance. To increase the hardness, the material is hardened by conventional heat treatment techniques.

Steels that are very well corrosion-resistant are in most cases difficult to harden by heat treatment and have poor tribological properties, with consequent inadequate wear characteristics for the use in the additive shaver mentioned above. The wear of the outer blade is not just caused by contact with the moving (e.g. rotating or linear moving) blade inside the shaver head but also through the contact with the skin and hairs, which can be very tough, especially as stubble.

The hardness can be further improved by plasma nitriding, as has been demonstrated by patent documents U.S. Pat. No. 5,851,313 and DE 10039169. In this context also the Japanese document JP 60162766 is relevant. This document discloses the nitriding of a stainless steel or nickel cutting element for achieving a better durability and a lesser sliding load, for example a better smoothness. According the Japanese document, only the outside of the blade is hardened at one side by a simple method.

The object of the invention is to provide a means for manufacturing cutting elements that are both very well corrosion-proof and very wear-resistant on all sides.

This object is achieved by a cutting element, as used in an electric shaver, manufactured from maraging or precipitation-hardenable stainless steel or austenitic stainless steel with a surface hardened by plasma nitriding, characterized in that the cutting element is hardened by plasma nitriding on all surfaces of the blade, and a plasma nitriding hardened layer consist of a surface compound top layer of steel supersaturated with nitrogen and a diffusion layer adjoining the top layer with a hardness ranging from the hardness of the top layer to the hardness of the steel before hardening by means of plasma nitriding, said surface compound layer preferably having a hardness of at least 1300 HV, and in the case of austenitic stainless steel at least 1100 HV. The solution provided by the present invention is to comprehensively plasma nitride the cutting element, that is on all sides, de facto giving the entire blade an outer layer of hardened material, making it better wear-resistant on all sides where wear could possibly occur. The advantage of the presence of the diffusion layer is that it additionally strengthens the base material and supports the load-bearing capacity of the compound layer. With a cutting element is meant an individually working shaver blade or a shaver blade that works in cooperation with another shaver blade. Such a construction of cooperating shaver blades may be found, for example, in a shaver with an internal rotating cutting element that is surrounded by an external counter cutting element (cap) that has a stationary position. Another construction of cooperating shaver blades can for instance be found in a shaver with an internal reciprocating (e.g. linear) moving cutting element has is surrounded by an external counter cutting element (cap) that has a stationary position. Both the internal rotating moving element and the external stationary counter cutting element are denoted cutting elements in this document.

In a preferred embodiment, the cutting element has a hardened supersaturated top layer with a thickness that ranges from 5 μm to 25 μm and diffusion layer with a thickness that ranges from 5 μm to 20 μm. In another preferred embodiment, the hardness of the hardened supersaturated top layer is at least 1300 HV, and in the case of austenitic stainless steel at least 1100 HV. The cutting element may be designed for use in a shaver of the dry shaver type or for use in a shaver of the additive shaver type, for use in a rotating shaver type, a reciprocating shaver or a shaver showing another type of relative movement.

The invention also relates to an electric shaver provided with a cutting element as disclosed. Such a shaver has the advantages as mentioned above in relation to the cutting element according the invention. Once again is noted that the electric shaver according the present invention is not restricted to a specific type of electric shaver; all types of electric shavers can be provided with the cutting element as disclosed.

The invention also provides a method of manufacturing a cutting element, characterized in that a cutting element is formed of stainless maraging steel, whereupon the cutting element is hardened on all surfaces by means of plasma nitriding to a hardness of the top layer of at least 1300 HV. The method according the invention enables the manufacture of shaver components from non-hardened (austenitic) stainless steel, which components are hardened later in the production process by inward growth of a hard and wear-resistant compound top layer, thus simplifying the production process. The non-hardened stainless steel can be processed relatively easily. Another problem encountered in the process of manufacturing the cutting elements for the Coolskin® type shaver according to the prior art is that the hardenable steel used in the prior art for producing shaver heads (for example, Sandvik 1RK91 maraging steel used until now for the production of shaver heads) can only be bought from one source. This undesirable situation, both from a logistical and a commercial point of view, is now solved according the present invention as the method according the invention makes it possible to use hitherto unsuitable (and relatively inexpensive) types of steel for producing the cutting element according the invention. Nitriding parameters may be: temperature 300° C. to 500° C., process time of 5 to 40 hours, nitriding pressure 250 Pa to 550 Pa, and a pulsed plasma process.

The present invention will be elucidated below with reference to the annexed drawings, in which:

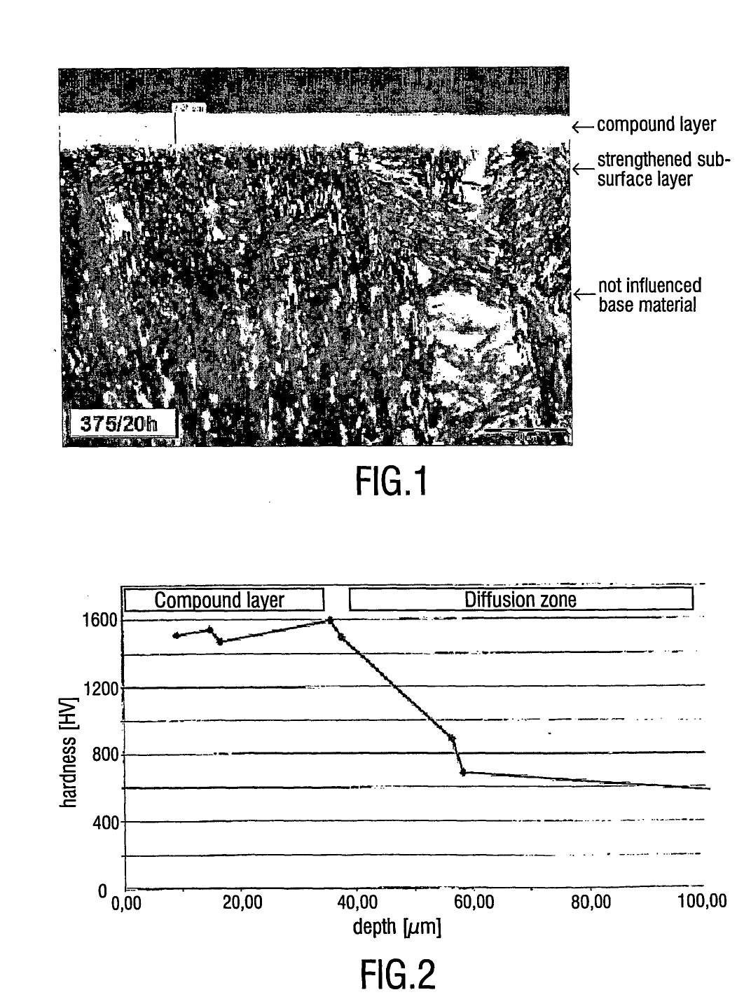

FIG. 1 is a microscopic view of nitrided 1RK91 maraging steel,

FIG. 2 shows a diffusion profile in NPR+hardened 1RK91 steel,

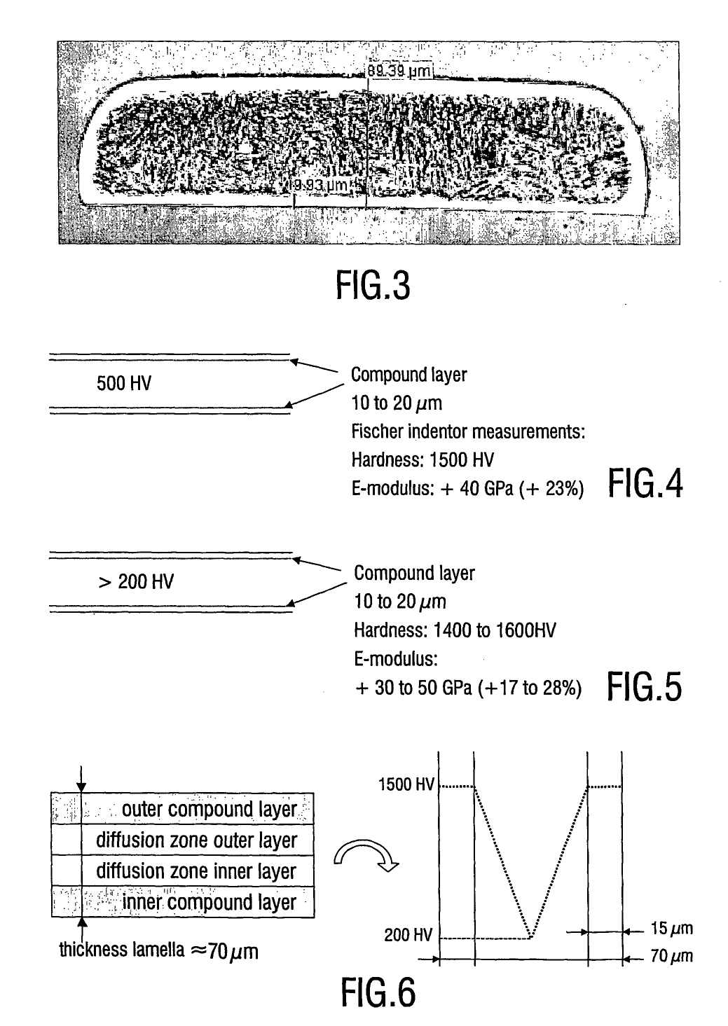

FIG. 3 is a cross-section of a hardened lamella,

FIG. 4 is a schematic lengthwise section of a lamella of stainless maraging steel,

FIG. 5 is a schematic lengthwise section of a lamella of austenitic stainless steel and

FIG. 6 is a schematic section of a lamella, showing compound layers and diffusion zones.

The present invention provides a method for the manufacture of a cutting element by hardening stainless maraging steel, which method consists in plasma nitriding of the manufactured cutting element in such a way that the entire surface of the blade consists of a compounds layer of supersaturated steel, below which lies a diffusion layer in which the nitrogen from the compound layer has diffused into the steel, creating a hardness gradient. A cutting element manufactured according to the invention has a hardness of around 1500 HV, which is exceptionally high in relation to the prior art.

Besides stainless martensitic maraging steel, austenitic maraging steel is also suitable for use in the manufacture of a shaver head according to the invention. Actually, austenitic stainless steel is preferred because of its greater corrosion resistance compared with martensitic steel; also it is more widely available. With plasma nitriding it can be made sufficiently hard-wearing, and if the nitriding temperature is kept below 450° C. the anticorrosive properties of the austenitic steel are not adversely affected.

During the nitriding process, nitrogen penetrates and diffuses into the base material from the outside inwards. In the so-called compound layer the hardness is quite even and the metal structure is supersaturated with nitrogen. The thickness of this layer depends on the duration of the nitriding process. Underneath this layer lies the diffusion zone, in which nitrogen diffuses into the base material, the hardness of which decreases with depth. FIGS. 1 and 2 illustrate this phenomenon.

Maraging steel and precipitation-hardenable stainless steel can undergo a precipitation hardening step prior to or together with the plasma nitriding step according to the invention.

As is shown in FIG. 6, the diffusion zones in a lamella of a shaver head according to the invention are nearly meeting or overlapping. The hardness of the outer surface depends on the material used. FIG. 4 shows a hardness of 1500 HV for the compound layer and an average hardness of the diffusion layer of 500 HV. For an austenitic stainless steel, the data are 1400 to 1600 HV and above 200 HV, respectively, as is shown in FIG. 5. These values are unusual and hitherto unknown in the state of the art. Since the diffusion zones underneath the compound layers are nearly meeting or even overlapping, the mechanical strength of the lamellac is considerably increased. Hardening of the metal is usually achieved at the cost of toughness. In other words, it becomes more brittle. If the blade were uniformly hardened through and through to a hardness of 1500 HV, it would become very brittle and consequently would snap easily. With the process according to the invention this disadvantage is avoided.

As is shown in FIG. 3, which shows a cross-section of a plasma-nitrided lamella, the compound layer is indeed covering the entire surface in an even manner, assuring sufficient wear resistance on all sides. Although U.S. Pat. No. 647,280 states that with plasma nitriding of intricate shapes it is difficult to achieve an even layer of hardened material (because of which a two-stage process for nitriding is proposed), the present manufacturing process does not suffer from this problem. As can be seen in the cross-section in FIG. 3, an even thickness of the nitrided layer is achieved.

Prior to the nitriding process, the maraging and precipitation hardenable steels must first be hardened by an ageing heat treatment. Optionally this may be combined with the nitriding process as this, according to the present invention, is carried out at the same temperature. The plasma nitriding process employed here is commonly known in the art.

### PREFERRED EMBODIMENTS

To better illustrate the present invention two examples are given below, in which stainless maraging steel and austenitic stainless steel, respectively, are used. These examples are strictly non-limitative, as any type of steel with suitable properties may be used.

### EXAMPLE 1

Manufacture of a shaver head according to the invention from 1RK91 maraging steel.

After manufacture, the cutting element is kept in a pulsed nitriding furnace at 375° C. for 20 hours in 475 Pa nitrogen gas pressure, during which the nitriding takes place. With an average thickness of the lamella of around 70 μm this results in a compound layer of around 10 to 20 μm. As can be seen in the schematic representation in FIG. 6, the diffusion zones just touch. In the case of 1RK91 steel, the hardness of originally 500 HV has been increased to 1500 HV on the outside of the compound layer. Also the Young modulus increases in the compound layer by 23%, rising from 177 GPa to 217 GPa.

### EXAMPLE 2

This proceeds in an analogous manner to example 1, but with the use of AISI 316 austenitic steel. The chosen temperature is 425° C. The resulting hardness ranges from the original 200 HV in the center core of the lamella to 1400 HV on the outside surface.

Thus it is shown that a variety of steels can be hardened by plasma nitriding to obtain a desired hardness of around 1500 HV. In either case the corrosion resistance was not impaired.

The method according to the invention may obviously also be applied to other devices that are subjected to high wear and corrosive conditions, such as, but not limited to, razors, rotating knives, cutting tools, certain automotive parts, etc.

1. Cutting element as used in an electric shaver, manufactured from maraging or precipitation-hardenable stainless steel with a surface hardened by plasma nitriding, characterized in that the cutting element is hardened by plasma nitriding on all surfaces of the blade, and a plasma nitriding hardened layer consist of a surface top layer of steel supersaturated with nitrogen and a diffusion layer adjoining the top layer with a hardness ranging from the hardness of the top layer to the hardness of the steel before hardening by means of plasma nitriding.

2. Cutting element as claimed in claim 1, characterized in that the thickness of the hardened supersaturated top layer ranges from 5 μm to 25 μm.

3. Cutting element according to claim 1, characterized in that the thickness of the diffusion layer ranges from 5 μm to 20 μm.

4. Cutting element according to claim 1, characterized in that the hardness of the hardened supersaturated top layer is at least 1300 HV.

5. Cutting element according to claim 1, characterized in that the cutting element is designed for use in a shaver of the dry shaver type.

6. Cutting element according to claim 1, characterized in that the cutting element is designed for use in a shaver of the additive shaver type.

7. Electric shaver comprising at least one of the cutting elements according to claim 1.

8. Method of manufacturing a cutting element, characterized in that a cutting element is formed of austenitic stainless steel, whereupon the cutting element is hardened on all surfaces by means of plasma nitriding to a hardness of the top layer of at least 1100 HV.

9. Method according claim 7, characterized in that, after the cutting element has been formed from stainless maraging steel or precipitation-hardenable stainless steel, the cutting element is precipitationally hardened prior to or simultaneously with the plasma nitriding.
